(19) United States
(12) Patent Application Publication
(10) Pub. No.: US 2009/0219711 A1
(43) Pub. Date: Sep. 3, 2009

(54) Lighted Bouquet

(76) Inventor: Katie V. Webb, Memphis, TN (US)

Correspondence Address: ROBERT M. SCHWARTZ, P.A., P.O. BOX 221470, HOLLYWOOD, FL, 33022, US

(21) Appl. No.: 12/038,923

(22) Filed: Feb. 28, 2008

(51) Int. Cl. F21V 33/00

(52) U.S. Cl. 362/122

(57) ABSTRACT

The present invention is an illuminated botanical assembly having a light and a plurality of botanical objects.

### BACKGROUND OF THE INVENTION

Much time and effort goes into creating a creative floral displays. The present invention has achieved an effective way of incorporating light into floral and botanical displays.

### BRIEF SUMMARY OF THE INVENTION

The present invention provides for a botanical bouquet assembly that incorporates at least one source of light. The botanical bouquet assembly may be floral, botanical, and combinations thereof.

As used herein, botanical is intended to refer to any variety of plant species, and will further include displays of flowers, plants, leaves, and the like.

In a preferred embodiment, a botanical bouquet assembly incorporates a source of light that emits a limited amount of heat. It is important that the source of light into a limited amount of heat due to the fragile nature of natural botanical specimens. Flowers and plants may wither quickly when exposed to excessive heat. Such sources of light may include but would not be limited to, fiber-optic lights, light emitting diodes, compact fluorescent lights and the like. The size of the light sources will depend upon the size of the bouquet assembly in which incorporation of light is desired. A handheld bouquet assembly may be able to accommodate more sources of light then a corsage or boutonnière. Additionally, a botanical assembly that is placed on display such as a centerpiece or other arrangement not intended to be carried, may incorporate an even larger amount of the incorporated lights.

In a preferred embodiment, the present invention is an illuminated botanical assembly having:

a. a light; and

b. a plurality of botanical objects.

The assembly will require a source of electricity. The electricity may be a battery directly connected to the light wiring.

Alternatively, the source of electricity is may not physically connected to the assembly but would be supplied by induction.

The light or lights may be centrally positioned within the plurality of botanical objects or the lights may be interspersed amongst the plurality of botanical objects.

In one embodiment, the lights may be attached to the edges of various botanical objects such as plant leaves and flower petals. The attachment may be such that a lighted border is created around the edge of the various botanical objects in the bouquet assembly.

The assembly may have flowers, individual flower petals, leaves, or combinations thereof.

The assembly has a base or holder configured for holding the assembly. The holder may be any acceptable mechanism for securing the botanical bouquet into position. In one embodiment, the holder has a plurality of bendable tabs, and the bendable tabs are moved into position to both hold a battery assembly in position and to hold the entirety of the botanical bouquet in position.

The base may be worn on the wrist of a user, carried by the user, or worn by the user such as a corsage or boutonnière.

### BRIEF DESCRIPTION OF THE DRAWINGS

FIG. 1 is a perspective view.

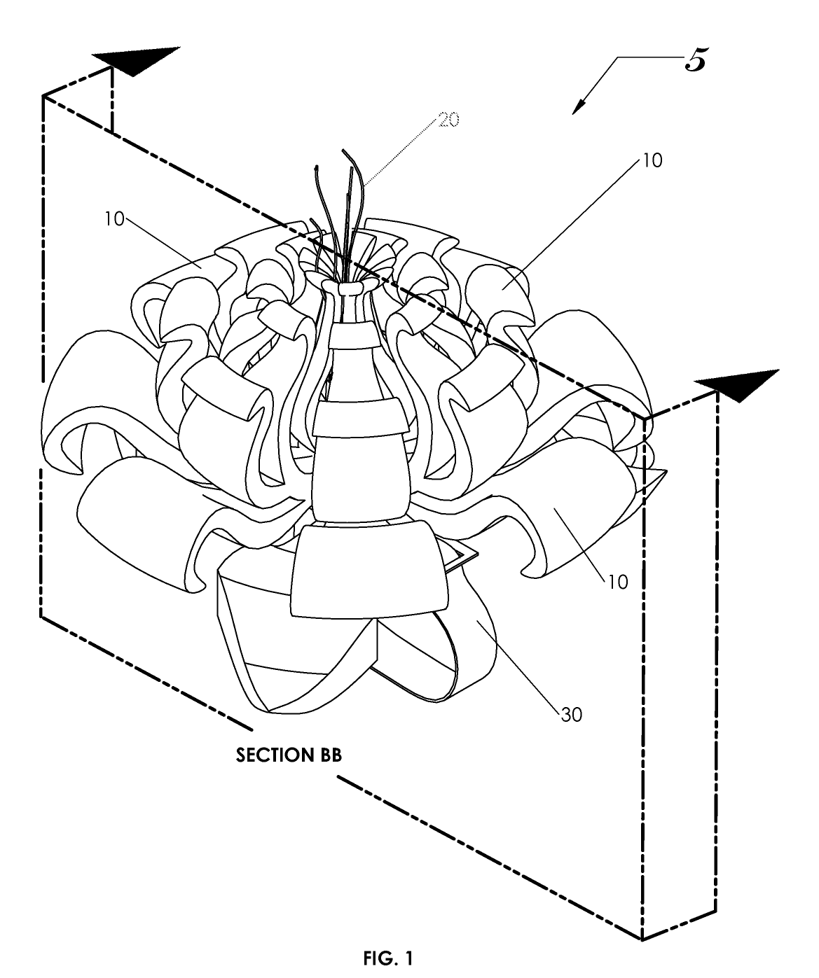

FIG. 2 is a perspective disassembled view.

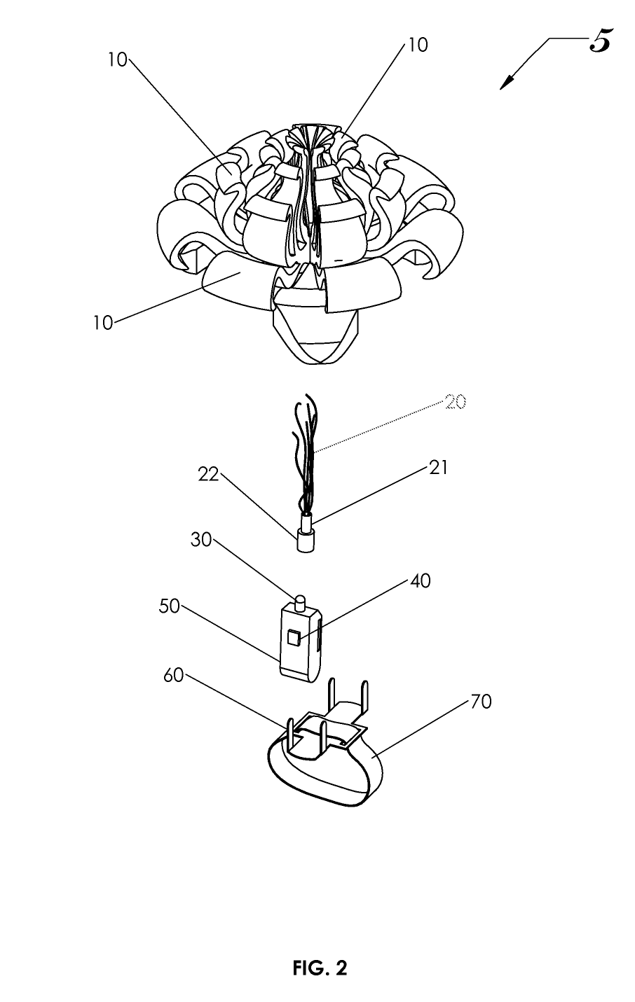

FIG. 3 is a bottom-up perspective view.

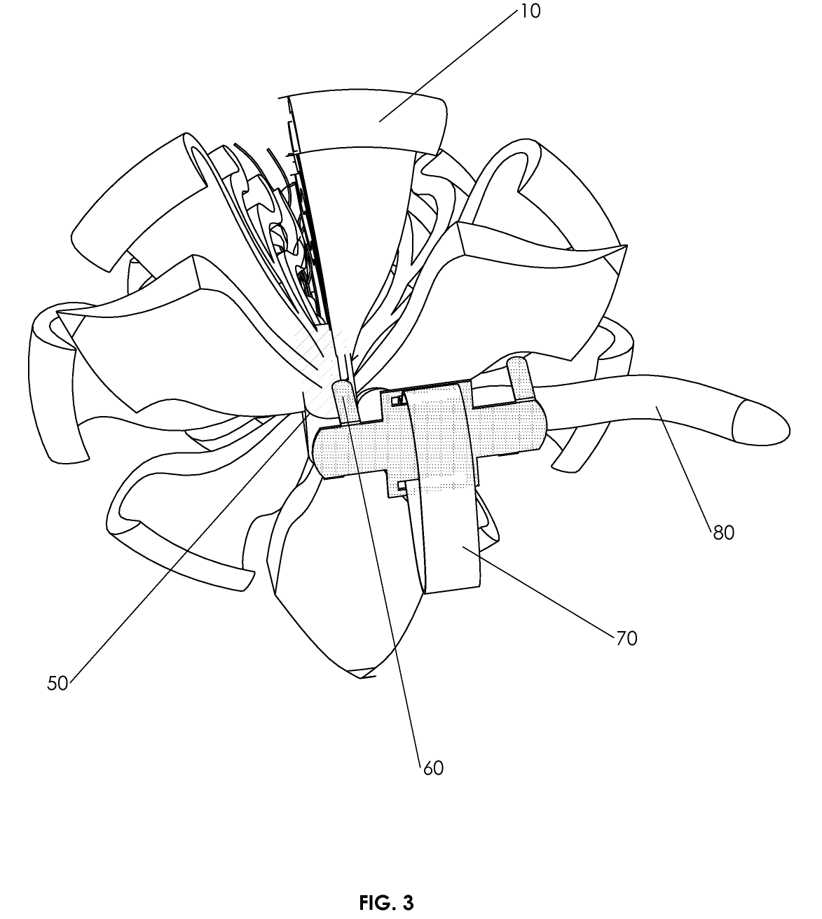

FIG. 4 is a section view.

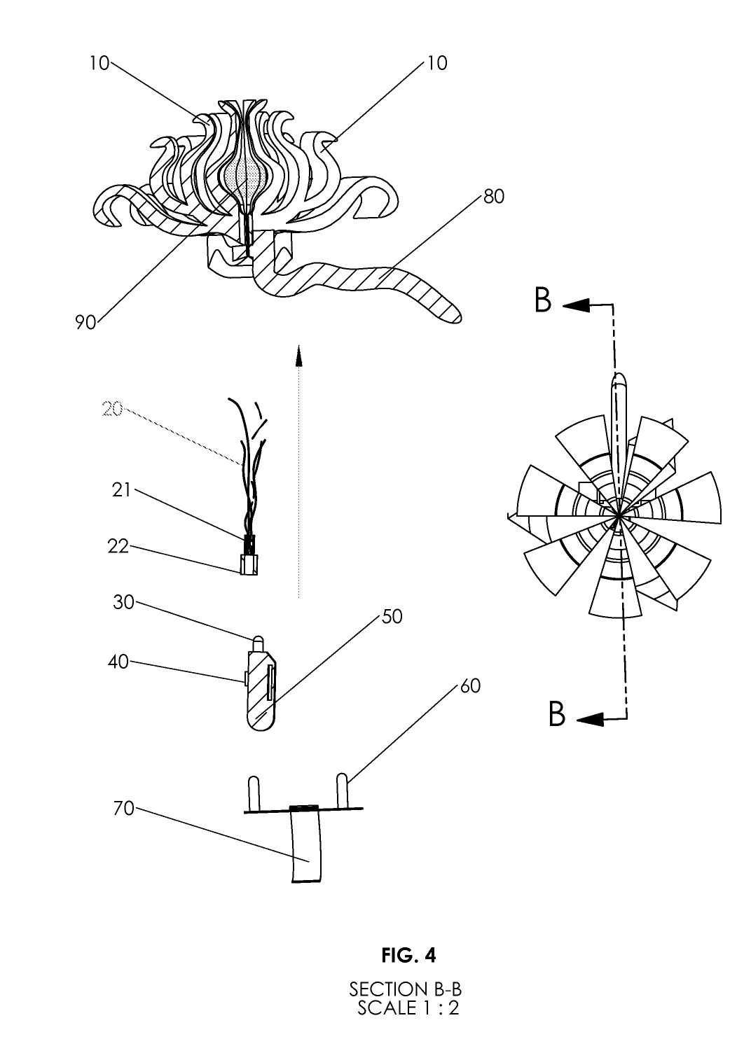

### DETAILED DESCRIPTION OF THE PREFERRED EMBODIMENTS

Assembly 5 has petals 10 that are supported by holder 30. Lights 20 extend from light holder 21 that is positioned on a light holder assembly 22. Light holder 22 interconnects with connector 30 that is incorporated onto battery assembly 50. Battery assembly 50 has power switch 40 four commencing and ceasing power supply to lights 20. Battery assembly 50 affixes to holder 60. Holder 60 may optionally have wrist strap 70.

The assembly may have stems 80 extending past the periphery of holder 60.

The embodiment in the figures show lights 20 as fiber optic lights that are incorporated within central cavity 80. Light holder assembly 22 has a female recess for interacting with connector 30 that is a male electrical connector.

Holder 60 has bendable tabs that are used both to hold battery assembly 50 and also secured to the underside of the botanical bouquet a portion of assembly 5.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An illuminated botanical assembly comprising:
a. a light; and
b. a plurality of botanical objects.

2. The assembly of claim 1 comprising a source of electricity.

3. The assembly of claim 2 wherein said source of electricity is a battery.

4. The assembly of claim 2 wherein the source of electricity is not physically connected to the assembly.

5. The assembly of claim 4 wherein the electricity is supplied by induction.

6. The assembly of claim 1 wherein the light is a fiber optic light.

7. The assembly of claim 1 wherein the light is centrally positioned within the plurality of botanical objects.

8. The assembly of claim 1 where the light is interspersed amongst the plurality of botanical objects.

9. The assembly of claim 1 wherein the plurality of botanical objects are flowers, individual flower petals, leaves, or combinations thereof.

10. The assembly of claim 1 comprising a base for holding the assembly.

11. The assembly of claim 10 wherein the base is worn on the wrist of a user.

12. The assembly of claim 10 wherein the base is carried by the user.

13. The assembly of claim 10 wherein the base is worn by the user.
